(19) United States
(12) Patent Application Publication
(10) Pub. No.: US 2025/0244602 A1
(43) Pub. Date: Jul. 31, 2025

(54) METHOD FOR ENABLING SINGLE LENS TO RECOGNIZE 3D FEATURES OF OBSERVED OBJECT

(71) Applicant: BEIJING JIAOTONG UNIVERSITY, Beijing (CN)

(72) Inventors: Ran XU, Beijing (CN); Miao Wang, Beijing (CN); Yu-Gong Xu, Beijing (CN)

(21) Appl. No.: 18/422,198

(22) Filed: Jan. 25, 2024

(51) Int. Cl. G02B 30/36

(52) U.S. Cl. CPC G02B 30/36

(57) ABSTRACT

A method for forming an artificial retina, wherein a light is deflected from its central axial and projected in a first direction and in a second direction, causing a focal length perturbation, and obtaining at least one first two-dimensional image with a first temporary contour shadow within a visual dwell time and at least one second two-dimensional image with a second temporary contour shadow within the visual dwell time, so that within a visual persistence time range, multiple two-dimensional images reflected from different angles can enter a retinal membrane to directly see three-dimensional life scenes by “looking” instead of “calculating”, thus saving much cost for making a real-time 3D viewing with only one lens.

### FIELD OF THE INVENTION

The present invention relates to a method for forming an artificial retina, a stereoscopic visual composition that uses “seeing” instead of “calculating”, in which a frequency conversion light source is actively projected at multiple angles, excites instantly changing shadows at edges of an observed object, so that an observer can directly see the three-dimensional features of the object to identify the object directly.

It can also be used as input information for optical calculations to restore a geometric shape of 3D objects.

The present invention has broad applications, such as enhancing the stereoscopic effect of single lens photography, assisting monocular vision robots in recognizing stereoscopic objects, making stereoscopic vision sensors more miniaturized, and preparing monocular stereoscopic vision auxiliary glasses.

### PRIOR ART

In daily life, each eye of a person sees a two-dimensional image, and the two-dimensional images seen by both eyes are synthesized into a stereoscopic image on the retina. Based on this biological knowledge and by the principles of bionics, stereoscopic movie technology, virtual reality technology, and other technologies have been developed. Their common features are dual lens shooting, dual lens projecting, and being viewed with grating glasses. Particularly, a virtual reality technology requires dual lenses space shooting and “stitching” algorithms, which not only requires large storage capacity, high requirements for computer configuration, and large amount of computation, but also results in high costs in production and application as well as poor real-time and inevitable local image distortion.

In prior art, binocular stereo vision is a common form of machine vision based on the parallax principle and utilizes imaging equipment to obtain two images of the observed object from different positions. By calculating the position deviation between the corresponding points in the image, three-dimensional geometric information of the object is obtained. The obvious drawbacks of using binocular stereo vision are that it requires a sufficient computing power and takes a relatively long time to form 3D images, resulting in high costs, relatively complex equipment, and difficulty in fully miniaturizing, which is not conducive to real-time 3D image formation.

Thus, people have been attempting to develop a monocular stereo vision for applications, such as computer vision and machine vision, and so on. However, previous research on monocular stereo vision has been chiefly based on complex mathematical algorithms, requiring a certain amount of computational power. It has not been able to achieve engineering applications.

For example, US2018/0091718A1 discloses a camera for capturing stereoscopic images with a single lens, which maintains its shooting position and sequentially illuminates the subject's surfaces from different angles to obtain multiple two-dimensional photos with shadows from the different angles. Then, through later mathematical algorithms for synthesis, a 3D image is formed, which is a calculation result of pure geometric relationships. Despite this, the obtained images are relatively accurate, but there is a drawback, lack of real-time image formation.

For some scenes that do not require a precise understanding of the 3D image details of observed objects, such as the recognition of obstacles in front during autonomous driving, the recognition of the shape of foreign objects on the wall during gastrointestinal optical detection, and the recognition of road surface protrusions and depressions when monocular individuals walk under insufficient lighting conditions, only real-time and rapid recognition of the saliency of the three-dimensional features of the objects involved in the observation range is required, instead of precise geometric structures. The intermediate information of the process does not need to be stored entirely for post-processing. In these cases, using the traditional “binocular imaging+post-processing” method can waste unnecessary cost and time. In response to the above application scenarios, the present invention proposes a method of using multi-point, multi-angle, and variable frequency light sources to actively illuminate an observed object, “stimulating” the observed object to produce instantly changing shadows, thereby enabling the “single lens observer” to “see” the three-dimensional features of the observed object in real-time. Compared to traditional methods, the method proposed by the present invention has stronger real-time performance, is simpler and easier to implement, and has lower implementation costs.

In addition, the method of using changing light sources to stimulate instant shadows to assist monocular recognition of the stereoscopic features of observed objects also has a daily application-assisting glasses for monocular stereo vision, which enables monocular individuals to quickly judge the sudden changes in road height under insufficient lighting conditions, such as steps. Monocular patients require monocular stereo vision assistance glasses, for which patients undergoing postoperative rehabilitation of one eye, or some elderly individuals, and there exists objectively a particular demand in market. Unfortunately, its solution has not yet been reported in academic journals or patent literatures, and such products have not been seen in the market.

Before the present invention, when it comes to “assisting glasses for monocular stereo vision”, people would naturally think of traditional ways such as “artificial vision” based on applied mathematical algorithms and “human-machine interface” based on biology, which have long been “complicated”. They did not expect “it is so simple” to directly “see” the stereoscopic features of observed objects by changing the light source to excite instant shadow images.

### SUMMARY OF THE INVENTION

One object of the present invention is to provide a method for assisting a single lens to recognize the three-dimensional features of an observed object, which uses changing shadows excited by actively projected multi-angle, variable frequency light sources to confirm the existence of the three-dimensional features of the object, indirectly achieving the 3D vision, and avoiding the complex mathematical algorithms and computational hardware devices required for traditional post-processing processes.

Another object of the present invention is to provide a method for enabling a single lens to “see” multiple two-dimensional images of the same object from different angles within an extremely short time difference. The method controls the frequency and angle of the projected light source to flicker at least twice from different angles within the visual persistence time range of the human eye. This allows the “single lens” to “see” two or more two-dimensional images with different shadows within the human visual persistence time. They can generate 3D images directly in the human brain or through post-processing techniques, thus replacing “two two-dimensional images at different angles at the same time” with “two two-dimensional images at different angles in a very short time difference” to form stereo vision.

Another object of the present invention is to provide assisting glasses for monocular stereo vision, in which the wearer uses a “monocular” as an image pickup element and adjusts the flashing frequency and projection angle of the projection light source to see different two-dimensional images with different temporary contour shadows during the visual retention time. These different two-dimensional images with different temporary contour shadows simultaneously enter the retina during the visual memory time, allowing one eye to recognize the three-dimensional features of the observed object.

Thus, according to the first aspect of the present invention, there is provided a method for assisting single lens recognizing stereoscopic features of an observed object, wherein multiple LED light beads (point light sources) are uniformly arranged in a circular shape around a single lens, forming a “light source variation ring”.

Preferably, the variable light source ring is rectangular or elliptical.

Preferably, the multiple light sources are oriented toward the object being photographed or observed, including an upper light source, a lower light source, a left light source, and a right light source.

Preferably, the variable light source ring is located between the image pickup element and the object being photographed or observed, close to one side of the image pickup element. The variable light source ring should be aimed at the object being photographed or observed.

Preferably, multiple point light sources are distributed on the light source variation ring, and each light source illuminates the photographed object according to the frequency and switching order set by the controller. The image pickup element sequentially receives the resulting reflected images.

Preferably, the upper and lower light sources are alternately illuminated and extinguished.

Preferably, the left light source and the right light source are alternately illuminated and extinguished.

Preferably, the interval between switching on and off is 1/25 second to ⅕ second.

Preferably, the frequency of each light source turning on and off in clockwise or counterclockwise order is 5-25 times per second.

Preferably, the frequency of switching between the upper and lower light sources on and off is 5-25 times per second.

Preferably, the frequency of switching between the left light source and the right light source on and off is 5-25 times per second.

Preferably, the brightness of the LED beads is automatically or manually adjusted by the electronic circuit controlled by a microcontroller to ensure comfortable viewing.

Preferably, each LED bead's lighting time and extinguishing interval are automatically or manually adjusted through electronic circuits to ensure clear viewing.

Preferably, the lighting sequence of each LED bead is automatically or manually adjusted through electronic circuits controlled by a microcontroller to ensure comfortable or clear viewing.

According to the second aspect of the present invention, there is provided a method for achieving a stereoscopic image by shooting with a single lens and projecting with two lenses, in which the two-dimensional images obtained by shooting with a single lens can be decomposed into two sets with a difference of one strobe interval (“on” and “off”) by filtering or other means; the two sets of two-dimensional images obtained by illuminating with a light source at different angles are synchronously projected onto a screen by two projectors, then a composite image with 3D vision can be formed.

According to a third aspect of the present invention, there is provided an assisting glasses for monocular stereo vision, wherein the variable light source ring is arranged on the glasses frame; the variable light source ring is located on the side of the eyeglass frame from the back to the eye (outer side); multiple point light sources are distributed on the variable light source ring, and point light sources arranged in different directions alternately illuminate the observed object at a set frequency; the reflected light provides information about the shadow changes of the three-dimensional object and stimulates the ciliary muscle, causing the focal length of the eye to perturb; during the visual dwell time, at least two different two-dimensional images of the observed object with different temporary contour shadows are seen successively, thus forming a stereoscopic view with one eye.

Preferably, the application range of the auxiliary glasses is controlled within 5-10 meters based on the maximum brightness of the selected LED beads.

Preferably, the brightness of the light source is manually adjusted to adapt to individual differences in the “ability to distinguish light and dark” of different individuals.

Preferably, the flicker frequency of the light source is manually adjusted within the range of 5-25 Hz to adapt to individual differences in visual persistence time among different individuals.

Preferably, the flashing mode of the light source is manually selected from top to bottom flashing, left to right flashing, clockwise flashing, and counterclockwise flashing to adapt to individual differences in the perception of “temporary shadows” by different people.

Preferably, the light source's luminous intensity, flicker frequency, and flicker mode are achieved by controlling the driving circuit with a microcontroller.

According to the present invention, the observed object is viewed from different angles in a switching manner. During the visual persistence time, at least two images of the observed object with different dynamic shadows are sequentially seen, and each image is directly superimposed on the retina, forming a three-dimensional observation experience in the viewer's brain. The method of the present invention is simple. Still, the image is never distorted, and it also avoids various mathematical algorithms and computational hardware devices, greatly reducing the cost of achieving stereo vision.

According to the present invention, a series of two-dimensional images captured through a “single lens+variable light source” can be decomposed into two sets of two-dimensional images with a stroboscopic interval illuminated by different angle light sources. These two two-dimensional images are synchronously projected onto a screen to form a composite image with 3D vision. From this, it is achieving a “three-dimensional movie” shot by a “single lens”

According to the present invention, monocular stereoscopic visual aid glasses can be provided, which enables people who can only live with one eye to see objects with a rich sense of stereoscopy. It is the first of its kind in the relevant field, and it is original.

Especially, previous researches on monocular stereo vision have been developing based on those complex mathematical algorithms. However, this invention breaks through the constraints of traditional thinking, overcomes the biases of conventional technology, and adopts a new approach based on temporary shadow addition technology to develop a new monocular stereo vision technology solution, abandoning traditional complex “stitching” algorithms, ensuring real-time results and avoiding image distortion due to the lack of computational time. And the number of expensive lenses has been halved. Therefore, this is a breakthrough in stereo vision technology.

### BRIEF DESCRIPTION OF ACCOMPANYING DRAWINGS

FIG. 1 is a schematic diagram of obtaining a stereoscopic image using a single lens according to the present invention.

FIG. 2 is a photo of the experimental device for monocular stereoscopic vision-assisted glasses according to the present invention.

FIG. 3 is a photo of the inventor of the monocular stereo vision assisted glasses according to the present invention in the experiment.

FIG. 4 is a structure diagram of the control board of the microcontroller. The control logic is as follows: (1) The driving circuit is controlled by a microcontroller, which controls the LED to emit light and can flash at a set time interval; (2) The microcontroller adopts pulse width control (PWM) to control the luminous intensity of the LED; (3) The current light source adopts a 120-degree fixed focus lens, which can be optionally equipped with a zoom lens (only suitable for instruments, the zoom lens is large and not suitable for wearing), and microcontroller micro-controller controls the zoom; (4) The line controller and communication interface are used to set the controller's light control parameters; (5) The power supply stabilizing circuit provides a stable DC power supply for the circuit board.

FIG. 5 is a control circuit diagram.

### BEST MODE FOR CARRYING OUT PREFERRED EMBODIMENTS

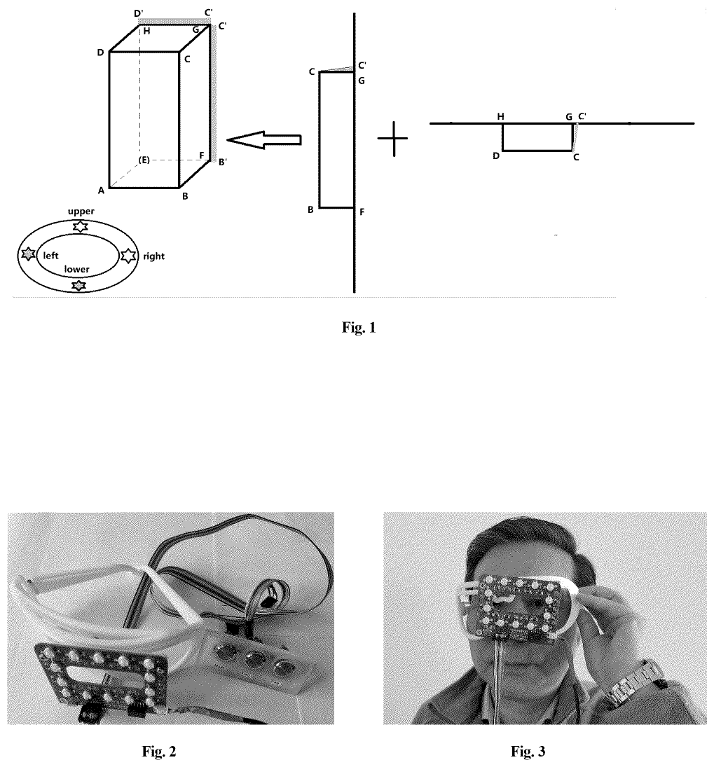

According to an embodiment of the present invention, as shown in FIGS. 1-5, the device for obtaining stereoscopic images with a single lens includes a variable light source ring, hollowed out in the middle as a channel for obtaining image signals. The variable light source ring is located between the image pickup device and the object being photographed ABCD-EFGH, close to the image pickup device. The variable light source ring should be aligned with the object being photographed. The variable light source ring is divided into four parts: left, upper, right, and lower, with multiple point lights distributed in each part. By setting the controller, each part of the light source alternately flashes at the set frequency to illuminate the photographed object, and the resulting images are sequentially picked up by the image pickup device.

In other embodiments, the variable light source ring can also be circular ring circular, diamond, or polygonal. Multiple light sources can illuminate portions in a cyclic order based on their orientation, either clockwise or counterclockwise, or according to other patterns. Preferably, the light source is an LED lamp. The controller is designed and prepared based on existing technology.

As shown in FIG. 1, under the working condition where the upper light sources are off and the lower light sources are on, the upper edge CD of the photographed object forms a shadow C′D′ on the background. When the right light sources are turned off and the left light sources are turned on, the right edge BC of the photographed object forms a shadow B′C′ on the background. When light sources from different angles flicker alternately, dynamic shadows reflecting the three-dimensional features of the object will appear around the observed object. The size of shadows depends on the distance and angle between the light sources and the observed object.

According to the principle of human vision, in a static light environment, one eye usually can only see two-dimensional information. To generate stereoscopic vision in a single eye, it is necessary to generate “near and far visual tiny vibrations” between the object being viewed and the retina. Therefore, it is to artificially create “tensioned and relaxed tiny vibrations” in the ciliary muscles. When the human eye looks at an object, the slight changes in the degree of relaxation of the ciliary muscles can cause a slight change in the curvature of the eye's lens, resulting in a slight change in the focal length of the lens's convex lens. This object can form multiple distinct images with slight differences on the retina. Because the brain can perceive the distance of objects based on the degree of relaxation of the ciliary muscles, it can create artificial three-dimensional vision. This means that a three-dimensional image can be formed in the brain by using an eye to view a series of different two-dimensional images of the same object at slightly different lens curvatures at different times. This inference has been confirmed in practice: by causing the lens's focal length to vibrate slightly relative to the object being photographed (also known as “perturbation” or “micro-vibration”), a single lens can obtain a series of different two-dimensional images at slightly different focal lengths at different times. Then, a certain three-dimensional image can be viewed by playing the single lens according to frequency of the video. The present invention utilizes a light source with both angle and frequency changes, and adjustable brightness, to illuminate the observed object. Essentially, it enhances the stimulation the eyes or the perturbation of the lens focal length through technical means, thereby enhancing the effect of single lens “viewing” three-dimensional features. Therefore, the inventor believes that under the active projection of a variable light source, the reflected light on the surface of the observed object dynamically stimulates the ciliary muscle, causing it to vibrate accordingly, resulting in a small change in the curvature of the eyeball lens and causing perturbations in the focal length of the observed object. This series of changes can make monocular stereoscopic vision from “impossible” to “possible” in daily life. As an application in everyday life, the present invention can provide a kind of monocular stereoscopic visual aid glasses.

Another embodiment of the present invention is to continuously capture the observed object using the method of “single lens+variable light source” mentioned above, and then use specialized software tools to decompose the obtained series of two-dimensional images into two sets of images (two images with a certain horizontal parallax) based on time intervals, each with a “strobe interval” difference. A stereoscopic video with clear depth can be achieved by synchronously projecting these two sets of images using two projectors. This embodiment can be used for scenes where the shooting space is extremely narrow and unsuitable for dual-lens shooting (such as microcapsule gastroscopy detectors, etc.).

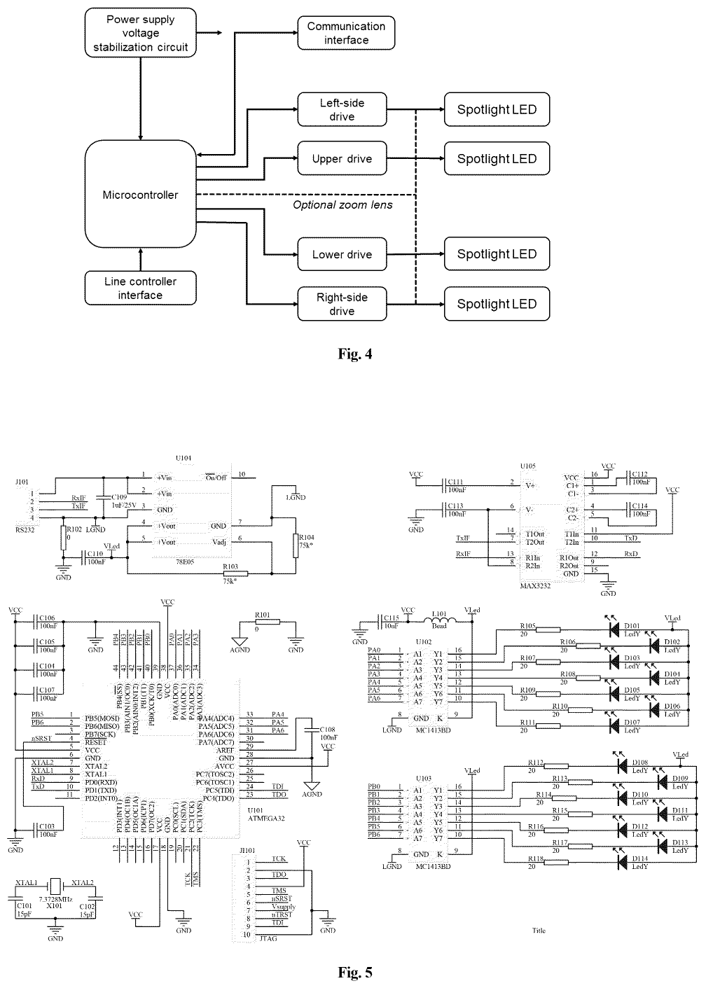

Based on the above ideas, the inventor has designed a specialized electronic circuit (FIG. 4 and FIG. 5) that can adjust the illumination angle and frequency of the light source to form changing shadows, and the reflected light can give people stereoscopic vision.

In various possible embodiments, the variable light source ring can be elliptical, circular, rectangular, diamond, or polygonal; The multiple point light sources are the upper point light source, the lower point light source, the left point light source, and the right point light source. The upper point light sources and lower point light sources are performed to switch between each other, and the left and right point light sources switch between each other. Preferably, the point light source can be an LED bead.

Preferably, the brightness of each point light source is adjusted automatically/manually. The lighting time and extinguishing interval of each point light source are automatically/manually adjusted. The lighting sequence of each point light source is automatically/manually adjusted to ensure clear and comfortable viewing.

According to an embodiment of the present invention, the working principle of monocular stereo vision auxiliary glasses is to uniformly arrange a certain number of point light sources along the periphery on the outer side of the eyeglass frame (the side close to the eye is “inner”, and vice versa is “outer”), which can be used to illuminate the observed object. The number of point light sources can be selected as a basic requirement to distinguish an object's contour within a range of about 5 meters. And the reflected light provides judgment on whether the observed object is three-dimensional. The luminous intensity and flicker frequency of the point light sources are controlled as parameters by a micro-controlled driving circuit (which can be achieved using prior art). Users can adjust the luminous intensity of the point light sources according to the background brightness level, to be able to clearly distinguish the observed object. At the same time, users can adjust the flashing modes (i.e. up and down flashing, left and right flashing, and up, down, left and right flashing simultaneously) and flashing frequency (the frequency adjustment range is the frequency range corresponding to the objective law of the “visual persistence” time of the human eye. Considering individual differences, for example, it can be set to 5-25 Hz (also a prior art) of the four side point light sources, until the dynamic shadow effect of the observed object is the best.

When using, it is necessary to adjust the luminous intensity of the point light sources to clearly distinguish the observed object and its surrounding environment. The purpose of adjusting the flicker mode and flicker frequency of a point light source is twofold: 1) it is hoped that the incident light flashing in different directions and frequencies can form “dynamic shadows” around the observed object as input information for perceiving the “three-dimensional” effect; 2) Stroboscopic reflected light from different angles stimulates changes in the degree of ciliary muscle relaxation, forming a regulatory effect of the eye following changes in reflected light. This allows the single eye to see no less than two images of the same object from different angles during the visual persistence time interval to create an instant stereoscopic sensation in the user's brain. By utilizing the artificial “dynamic shadows” and objective laws of “instant memory of the eyes” and “visual persistence of the eyes”, the human brain's ability to judge three-dimensional objects is stimulated and mobilized.

One of the inventive points of this invention is to use the natural law of actively adding “temporary shadows” or “dynamic shadows” to generate stereo vision, and to invent a kind of auxiliary glasses for monocular stereo vision. The simplest, most effective, and most economical technical solution successfully breaks away from the traditional “artificial vision” thinking. It avoids complex and massive mathematical algorithms, as well as difficult problems such as electronic devices and human brain neural interfaces that cannot be achieved quickly.

The electronic circuits, controllers, components, auxiliary glasses structure, manufacturing process, material selection and formula, physical parameters of light used in the present invention, packaging and maintenance methods of the present invention, etc. that implement various functions of the present invention, belong to the scope of prior art and do not need to be elaborated here.

The present invention uses a “stroboscopic light source” to illuminate the observed object, creating a “temporary shadow” around it to enhance the three-dimensional sense of the observed object. The “luminous intensity”, “flicker mode”, and “flicker frequency” of the light source in the present invention can be manually adjusted to stimulate the relaxation changes of the ciliary muscle of the wearer with different brightness, direction, and frequency of incident light, forming an adjustment effect of the eyeball following the reflected light, To allow different wearers to adapt to “temporary shadows” and their own “visual retention time”. The “flicker frequency” of the light sources of the present invention is adapted to the “visual persistence time” of the human eye, and considering individual differences between different individuals, it is set to be adjustable within the range of 5-25 Hz. The point light sources of the present invention can be a spotlight LED, and the number of point light sources is suitable if clearly distinguishing the contour of an observed object within a range of about 5 meters is possible.

The above has already introduced two key issues of the present invention: by changing the light source, how to moderately stimulate the ciliary muscle and how to automatically and naturally add shadows around or on the object's surface?

The number, intensity, frequency, and sequential illumination of point light sources are not essential technical features of the present invention. Based on the basic concept of the present invention and natural laws, engineering technicians in this field can easily determine these parameter modes themselves.

As mentioned above, the relationship between various parameters of the glasses and the three-dimensional sensation formed by stimulating the eyes' ciliary muscles is not a necessary technical feature of the present invention. According to the basic concept of the present invention, the wearer can manually adjust it until the wearer sees it clearly and comfortably.

Regarding embodiments with various parameters, there is no need to further describe non-essential technical features.

Each human eye's perception and response level to external stimuli are different, and the wearer can manually adjust it until the wearer sees it clearly and comfortably. Moreover, the mediation methods and software ideas are familiar to those skilled in the art.

Regarding which parameters to use, the present invention does not adopt the traditional “artificial vision” concept but displays instead. Instead, it displays different simulated images on the retina simultaneously, so there is no need to “determine the parameters”. If it is not suitable for oneself, “manually adjust” it to fit oneself.

Regarding how to achieve monocular viewing of stereoscopic objects, the present invention applies the natural laws of “dynamic shadows” and “visual persistence” to monocular stereo vision auxiliary glasses, allowing the wearer to see at least two simulated images with dynamic shadows about the observed object in visual persistence.

The above has fully disclosed the technical concept of the present invention. Based on this, those skilled in the art can discover new uses, develop further technical solutions, and make various supplements, improvements, modifications, replacements, and so on to the present invention. However, doing so will fall within the scope of patent protection limited by the attached claims.

1. A method for forming an artificial retina, wherein the method comprises:
irradiating, by a light source, an object to be watched in a first direction with a first angle with respect to an axial line to a central point of the object, causing a focal length of the light source changed tinily, and obtaining at least one first 2D image with a first temporary contour shadow within a visual dwell time;
irradiating, by the light source, the object in a second direction with a second angle with respect to the axial line to the central point of the object, causing the focal length of the light source changed tinily, and obtaining at least one second 2D image with a second temporary contour shadow within the visual dwell time; and
overlaying the first 2D image and second 2D images directly (without any computation), to form a composite image with a 3D vision sense on an image pickup element.

2. A method for realizing claim 1 for obtaining a 3D image of an object with a single lens, wherein the method comprises:
irradiating, by a light source, the object to be photographed in a first direction with a first angle with respect to an axial line to a central point of the object to be photographed, causing a focal length of the light source perturbating, and obtaining at least one first two-dimensional image with a first temporary contour shadow within a visual dwell time;
irradiating, by the light source, the object to be photographed in a second direction with a second angle with respect to the axial line to the central point of the object to be photographed, causing the focal length of the light source perturbating, and obtaining at least one second two-dimensional image with a second temporary contour shadow within the visual dwell time; and
overlaying the first two-dimensional image and second two-dimensional images directly to form a composite image with a 3D vision sense on an image pickup element.

3. The method of claim 2, wherein
the light source is set on a variable light source ring;
the first direction is different from the second direction;
the first angle is different from the second angle; and/or
the method further comprises: irradiating, by the light source, the object around the object, forming a series of the first two-dimensional images and the second two-dimensional images.

4. The method of claim 3, wherein
the variable light source ring is positioned between the image pickup element and the object to be photographed, and is close to one side of the image pickup element; when being used, the variable light source ring is aimed at the object to be photographed; and/or
a multiple of point light sources are distributed on the variable light source ring, which are divided into different groups according to different orientations; among each group of point light sources, when one group emits light, the other light sources are performed to turn off, and each group of light sources illuminate the object; each group of light sources sequentially illuminate the object; and the image pickup element receives the composite image.

5. The method of claim 3, wherein the variable light source ring is rectangular or elliptical.

6. The method of claim 5, wherein the multiple of point light sources face the object to be photographed, including an upper light source group, a lower light source group, a left light source group, and a right light source group.

7. The method of claim 6, wherein the upper light sources and lower light sources are switched on and off, or the left light sources and right light sources are switched on and off.

8. The method of claim 7, wherein
a time interval between switching on and off is 1/25 second to ⅕ second;
a frequency of each group of light sources turning on and off clockwise or counterclockwise is 5-25 times/second;
a frequency of switching between the upper and lower light sources on and off is 5-25 times/second; or
a frequency of switching between the left and right light sources on and off is 5-25 times per second.

9. The method of claim 3, wherein the point light source is an LED bead.

10. The method of claim 9, wherein a brightness of the LED bead is automatically or manually adjusted by an electronic circuit to ensure comfortable viewing.

11. The method of claim 9, wherein a time interval between the illumination and extinction of each LED bead is automatically or manually adjusted by an electronic circuit to ensure clear viewing.

12. The method of claim 9, wherein a lighting sequence of the LED beads is automatically or manually adjusted by an electronic circuit to ensure comfortable or clear viewing.

13. The method of claim 2, wherein each of the first two-dimensional images and the second two-dimensional images recorded in the image pickup element is sequentially displayed in a video frequency to exhibit a 3D sense in a viewer's mind.

14. An eyeglass for using claim 1 to a person who has to use his/her single available eye to enjoy a 3D sense in his/her mind, wherein a variable light source ring is arranged on an eyeglass frame; the variable light source ring is located on a side of the eyeglass frame facing away from his/her eye; a multiple of point light sources are distributed on the variable light source ring, and the light sources periodically illuminate an observed object separately and sequentially; lights reflected from the observed object stimulates his/her ciliary muscle, causing perturbation of his/her eye's focal length while the light sources irradiates the observed object in different directions; during a visual dwell time, at least two 2D images of the observed object with two different temporary contour shadows are seen successively, thus forming a 3D sense in the person's mind for an instant viewing with only one eye.

15. The eyeglass of claim 14, wherein the person keeps the observed object away from him/her in a range of 5-10 meters.

16. The eyeglass of claim 14, wherein a brightness of the light sources is manually adjusted to adapt to individual differences in an “ability to distinguish light and dark” of different individuals.

17. The eyeglass of claim 14, wherein a flicker frequency of the light sources is manually adjusted within a range of 5-25 Hz to adapt to visual persistence time among different individuals.

18. The eyeglass of claim 14, wherein a flashing mode of the light sources is manually selected from flashing up and down, flashing left and right, flashing clockwise in sequence, or flashing counterclockwise in sequence to adapt to different perception of “temporary shadows” by different people.

19. The eyeglass of claim 14, wherein a light source's luminous intensity, a flicker frequency, and a flicker mode are achieved by a controlling and driving circuit of a microcontroller.
